(19) United States
(12) Patent Application Publication
(10) Pub. No.: US 2008/0000357 A1
(43) Pub. Date: Jan. 3, 2008

(54) Hot beverage brewing device

(76) Inventors: Frank Yang, Rancho Palos Verdes, CA (US); Joseph Sandor, Santa Ana Heights, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/478,942

(22) Filed: Jun. 30, 2006

(51) Int. Cl. A47J 31/00

(52) U.S. Cl. 99/279

(57) ABSTRACT

A brewing device can include a pump and a heater configured to deliver heated water to a beverage ingredient receiving assembly. The brewing device can include a controller to regulate the operation of the various components and to interface with the user. The beverage ingredient receiving assembly can have a lid portion secured to a corresponding lower portion using a latching mechanism. A shower head can be used to distribute the heated water over the beverage ingredient and can be configured to maintain the filter or other brewed item within the filter tray after a beverage has been brewed. A handle positioned on the lid portion can be used to control the latch mechanism and position of the shower head relative to the adjacent filter tray. The filter tray has a plurality of diversion members configured to optimize the contact time between the heated liquid and the beverage ingredient.

### BACKGROUND OF THE INVENTIONS

1. Field of the Inventions

The present inventions relate to a device for making hot beverages and, more particularly, a brewing device that produces a hot beverage by forcing heated liquid through a beverage ingredient.

2. Description of the Related Art

A variety of electric hot beverage brewing devices are well known. For example, drip type brewing devices deliver heated water to a filter assembly at low pressure and permit it to slowly steep through the beverage ingredient. Pressurized systems which deliver heated water to the beverage ingredient under higher pressures, are generally capable of producing the brewed beverage in a shorter time period.

The components related to the interface between the heated water and the beverage ingredient in existing pressurized systems can be complex and unreliable. In addition, such systems fail to adequately address post-brewing cleanup problems related to the filter and beverage ingredient. Therefore, it is desirable to provide a simple, secure, effective and clean device for producing a brewed beverage.

### SUMMARY OF THE INVENTIONS

According to one embodiment of at least one of the inventions disclosed herein a brewing device comprises a diffuser member for dispersing a fluid over a beverage ingredient and one or more positioning members arranged to vertically move the diffuser member relative to the housing. The diffuser member may be configured to resiliently oppose a downward movement In another arrangement, the diffuser member is configured to move vertically in a housing. In some embodiments, the brewing device additionally comprises one or more biasing members configured to create a substantially upwards force on the diffuser member. In other embodiments, the biasing member includes a spring.

According to another arrangement of at least one of the inventions disclosed herein, the positioning member is arranged to move the diffuser by moving an actuation member. In one embodiment, the positioning member and the actuation member are attached to a rotatable rod. In yet another embodiment, the upwards force created by the biasing member is configured to move the diffuser member away from a lower surface. In one arrangement, the positioning member is a cam. In another arrangement, the cam includes a positive engagement surface.

In accordance with a further aspect of at least one of the inventions disclosed herein, a brewing device comprises an upper portion that includes a diffuser member and one or more upper latching members. The brewing device additionally includes a lower portion hingedly connected to the upper portion and configured to hold a brewable ingredient. The lower portion includes one or more lower latching members configured to lockingly engage the upper latching members as upper portion is moved close to lower portion. In another embodiment, the upper latching member, the lower latching member or both includes a sloped surface configured to facilitate the engagement between the upper and lower latching members.

In accordance with a further aspect of at least one of the inventions disclosed herein, a brewing device further comprises at least one disengagement member, which is configured to move the upper latching member, the lower latching member or both so as to cause upper and lower latching members to move out of a locking position. In another arrangement, the disengagement member is configured to move the latching member by moving an actuation member. In one embodiment, the disengagement and actuation members are attached to a rotatable rod. In yet another arrangement, the brewing device further comprises one ore more one positioning members configured to vertically move the diffuser member relative to the upper portion such that rotation of the rotatable rod can selectively control the vertical position of the diffuser member. In one embodiment, the disengagement member is a cam.

In accordance with a further aspect of at least one of the inventions disclosed herein, a brewing device comprises a tray configured to hold a filter and a beverage ingredient. The tray further includes one ore more outlets positioned on its bottom surface and a plurality of diversion members distributed along the bottom surface of the tray. In some embodiments, the diversion members are configured in more of a tangential than a radial arrangement, and are skewed relative to both a purely tangential and a purely radial arrangement. In another arrangement, the diversion members are formed onto the bottom surface of the tray. In yet other embodiments, the length of the diversion members positioned toward the center of the tray is generally shorter than the length of diversion members positioned further from the center of the tray. In another arrangement, the length of diversion members gradually decreases with proximity to the center of the tray. In one embodiment, the length of diversion members ranges between 1/32 inch and ¼ inch.

In accordance with a further aspect of at least one of the inventions disclosed herein, a brewing device comprises a tray configured to hold a filter and a brewable ingredient, a diffuser member positioned upstream of the tray and configured to discharge a fluid toward the filter and brewable ingredient and one ore more biasing members configured to impose a resilient force tending to move the diffuser member away from the tray. In some embodiments, the biasing member is a resilient member attached to a portion of the diffuser member. In another arrangement, the resilient member is an annular ring with at least one non-planar portion. In one embodiment, the resilient member is intermittently attached to the diffuser member. In yet another arrangement, the resilient member is welded to the diffuser member in at least two locations.

### BRIEF DESCRIPTION OF THE DRAWINGS

These and other features, aspects and advantages of the inventions disclosed herein are described below with reference to the drawings of a preferred embodiment, which is intended to illustrate and not to limit the inventions. The drawings comprise the following figures:

FIG. 1 illustrates a perspective view of a brewing device according to one embodiment.

FIG. 2 illustrates an exploded perspective view of the brewing device of FIG. 1 with various components detached.

FIG. 3 illustrates a schematic view of the liquid flow system that can be used with the brewing device of FIGS. 1 and 2.

FIG. 4A is a schematic sectional view of a valve that can be used with the liquid flow system of FIG. 3, in a closed state.

FIG. 4B is a schematic sectional view of a valve that can be used with the liquid flow system of FIG. 3, in an open state.

FIG. 4C is a top plan view of a valve member of the valve shown in FIGS. 4A and 4B.

FIG. 4D is a schematic sectional view of another valve that can be used with the liquid flow system of FIG. 3, in an open state.

FIG. 4E is a schematic sectional view of another valve that can be used with the liquid flow system of FIG. 3, in an open state.

FIG. 5 illustrates a perspective view of a beverage ingredient receiving assembly of a brewing device according to an embodiment.

FIG. 6 is a schematic diagram of a control system for a brewing device according to an embodiment.

FIG. 7A is a schematic illustration of a latch mechanism and a shower head of a brewing device in a first position.

FIG. 7B is a schematic view of the latch mechanism and shower head of FIG. 7A in a second position.

FIG. 7C is a schematic view of the latch mechanism and shower head of FIG. 7A in a third position.

FIG. 7D is a schematic view of the latch mechanism and shower head of FIG. 7A in a fourth position.

FIG. 8A is a perspective view of a beverage ingredient receiving assembly of a brewing device with certain interior portions exposed according to an embodiment.

FIG. 8B is a schematic side elevational view of the cam and shower head of FIG. 8A.

FIG. 8C is a cross-sectional view of the lid portion and filter tray of FIG. 8A.

FIG. 8D is a cross-sectional view of the latch mechanism of FIG. 8A.

FIG. 9 is a perspective view of a filter tray according to an embodiment.

FIG. 10 is a top plan view of the filter tray of FIG. 9.

FIG. 11 illustrates a perspective view of a lid portion with a shower head according to an embodiment.

### DETAILED DESCRIPTION OF THE PREFERRED EMBODIMENTS

The present apparatus described below and the various systems and features associated with its operation have particular utility in the context of a coffee brewer because they have particular utility in this context. The apparatus, as well as its various systems and features, however, can be used in other liquid dispensing machines, other kitchen and household appliances and other devices.

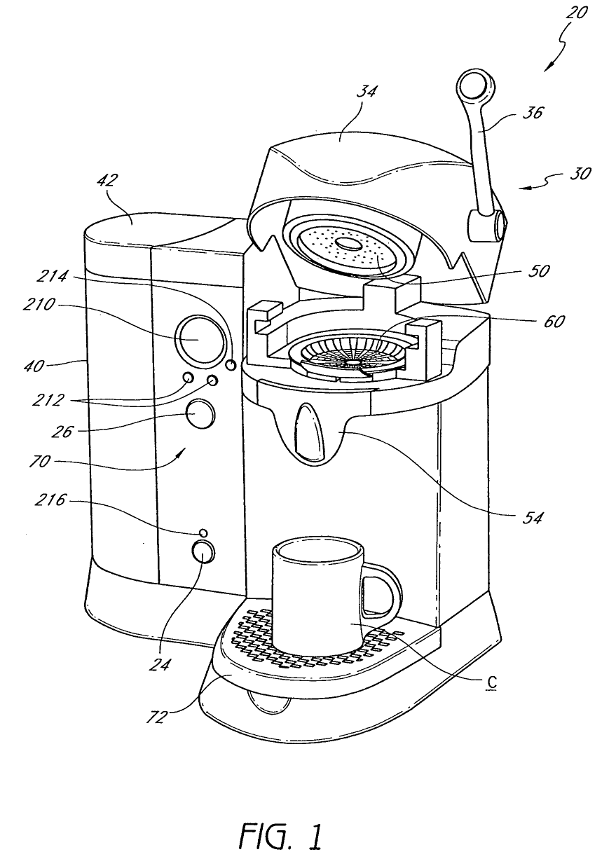

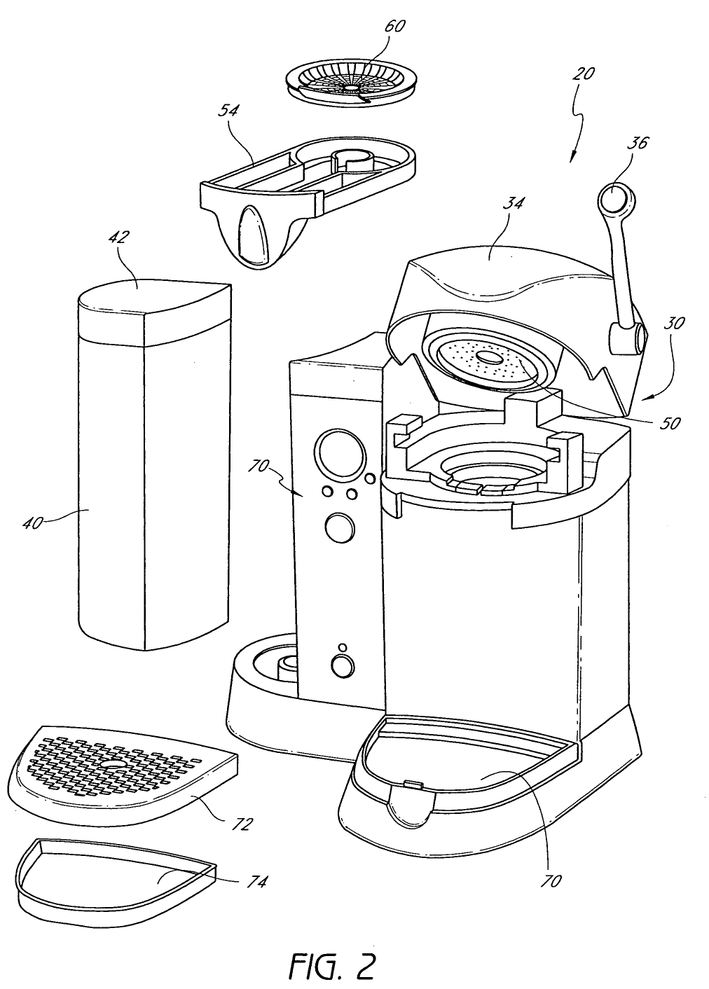

With reference to FIGS. 1 and 2, a brewing device 20 can include a beverage ingredient receiving assembly 30 comprising a lid portion 34 and a handle 36 rotatably attached to lid portion 34. The brewing device 20 can also have a water reservoir 40 with an upper closure 42. The water reservoir 40 can be configured for easy removal and attachment to the brewing device 20.

A plumbing system comprising a pump, a heater, valves and tubing, described in greater detail below can also be provided within the interior portion of the brewing device 20 to move and heat the water provided in the water reservoir 20 through a brewing process. The brewing device 20 can additionally comprise a brewing assembly configured to pass heated water through a beverage ingredient (e.g., coffee, tea, etc.) and guide the water into a cup, mug or other beverage container.

With reference to FIGS. 1 and 2, the brewing assembly can include a shower head 50, a filter holder 60 and a spout 54. As illustrated, the shower head 50 can be attached to the bottom of the lid portion 34. The filter holder 60 and the spout 54 can be configured to be easily removed from and repositioned on the brewer device 20.

A cup tray 72 and drip tray 74, which can be positioned underneath the brewing assembly, are provided to support a beverage container C (e.g., cup, mug, etc.). As depicted in FIG. 2, the cup tray 72 and the drip tray 74 are configured to be removably contained with a corresponding recessed area 70 on the bottom of the brewing device 20.

The brewing device 20 can also include a control panel 70 can be configured to permit a user to interface with and selectively operate the brewing device 20 using one or more user input devices (e.g., buttons), output devices (indicator lights and/or display modules). The control panel can be part of a control system configured to receive information from various sources (e.g., inputs from control panel 70, sensors, etc.) and to control the operation of the brewing device 20, which is described in greater detail below.

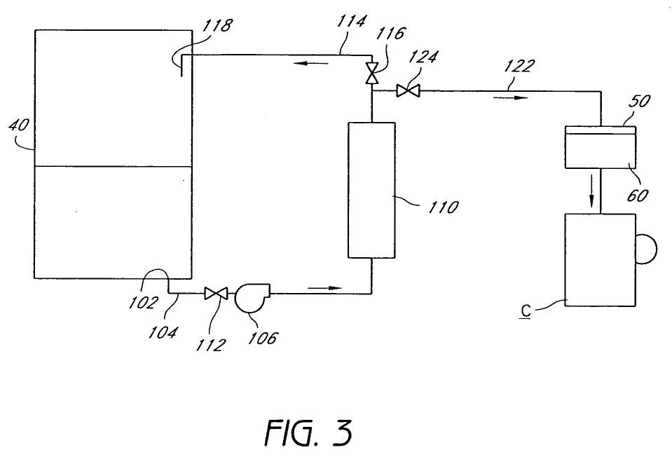

With reference to the schematic of FIG. 3, the water reservoir 40 can include an outlet 102 through which water can flow out of the reservoir 40. The outlet 102 can be located at the bottom of the water reservoir 40 and can be configured to fluidically connect the interior o the reservoir 40 to tubing 104 or another suitable conduit when the water reservoir 40 is secured on the brewing device 20 (FIG. 1). In some embodiments, this can be accomplished by providing a sealing valve (not shown) at the outlet 102 of the water reservoir 40.

The sealing valve can be designed to open and, thus, permit water to flow out of the water reservoir 40 when the water reservoir 40 is properly positioned on the corresponding site of the brewing device 20. The sealing valve can be configured to close when the water reservoir 40 is removed from the brewing device 20, ensuring that water does not leak from the outlet 102.

The water reservoir 40 can be constructed of any material. In some embodiments, the water reservoir 40 can be made of a transparent plastic material to allow a user to easily view its interior contents. However, it will be appreciated that any suitable material can be used to in lieu of or in addition to transparent plastic.

The water reservoir 40 can have a removable lid 42 (FIGS. 1 and 2) configured to snugly attach to the top open end to prevent the unwanted contamination of the water. As discussed in greater detail below with reference to the control system, the brewing device 20 can also include a water level sensor configured to detect a level of liquid in the water reservoir 40.

With continued reference to FIG. 3, a pump 106 can be located downstream of the outlet 102 and can be configured to draw a quantity of water out of the water reservoir 40 and pump it towards the heater 110. In some embodiments, the water can be transferred from the water reservoir 40 to the downstream components of the brewing device 20 through a network of tubing 104.

The tubing 104 can be adequately sized to accommodate the anticipated flow of water. Further, the tubing 104 can be configured to withstand the temperature and pressure fluctuations imposed by the pump 106, heater 110, and other components of the brewing device 20. Those of skill in the art will appreciate that the tubing may be constructed of any material approved to safely contact foods, including, but not limited to, silicone, plastic, rubber, stainless steel, other metals or alloys, etc.

With continued reference to FIG. 3, the pump 106 can be an electric pump and can be controlled by a control system. The pump 106 can be configured to generate a discharge pressure sufficient to transfer the required volume of water from the water reservoir 40 through the different components of the brewing device 20, including the heater 110, the shower head 50, the filter holder 60 (including the actual filter and beverage ingredient), the spout (not shown), etc. The pump 106 can also be sized so as to prevent damage to any system components as a result of over-pressurization or excessive flow.

In some embodiments, the pump 106 can be a vibration pump such as vibration pumps commercially available from UKLA. However, any suitable type of pump (e.g., volumetric pump) may also be used.

A one-way check valve 112 can be provided between the outlet 102 and the pump 106. As such, the pump 106 is maintained in a primed state. Additionally, when the reservoir 40 is disconnected, the valve 112 prevents water in the heater from flowing backwards through the pump 106 and out of the conduit 104.

With continued reference to FIG. 3, a heater 110 can be located downstream of the pump 106 and can be configured to heat the water to a desired temperature. The water heater 110 can comprise a heating chamber sized to contain a volume of water sufficient to brew one or more cups of a beverage (e.g., 5 oz, 8 oz, etc.).

Thus, where a single 5 oz. or 8 oz. cup of beverage is to be brewed, all the water used to produce the brewed beverage can be heated by the heater 110 before the pump 106 begins to operate. In some embodiments, the water is rapidly heated using a thermal block or other resistive heating element (e.g., coiled wire) located within the heating chamber of the heater 110. Alternatively, any other suitable type of heater 110 may be used to rapidly heat the water.

For example, an instantaneous flow-through heater (not shown) without a dedicated heating chamber can be used. Regardless of the type of heater used, a thermocouple or other temperature sensor can be incorporated into the system to ensure that the water has been heated to the target temperature. In some embodiments, the heater 110 can have a dedicated thermostat (not show) configured to maintain the water within the heater to a predetermined temperature. Further, in some embodiments, the heater 110 can include an adjustment device (not shown) to allow a user to change the predetermined temperature at which the heater 110 maintains the water held therein.

The heater 110 can also be connected to the water reservoir 40 through recirculation line 114 and the shower head 50 through brew line 122. A valve 116 can be disposed on the recirculation line 114 and can be configured to be normally open and to close when the internal pressure rises above a designated magnitude.

A valve 124 can be positioned on the brew line 122. The valve 124 can be configured to be normally closed and to open when the internal pressure rises above a designated magnitude. For example, in an exemplary but non-limiting embodiment, the valve 116 can be configured to close when the pressure in the line extending from the heater 110 to the valve 116 reaches 0.4 bar (5.8 psi). On the other hand, the valve 124 can be configured to open when the pressure in the line extending from the heater 110 to the valve 124 reaches 0.5 bar (7.3 psi). Those of skill in the art will appreciate that the valves 116, 124 can be configured to close and open at higher or lower internal pressures.

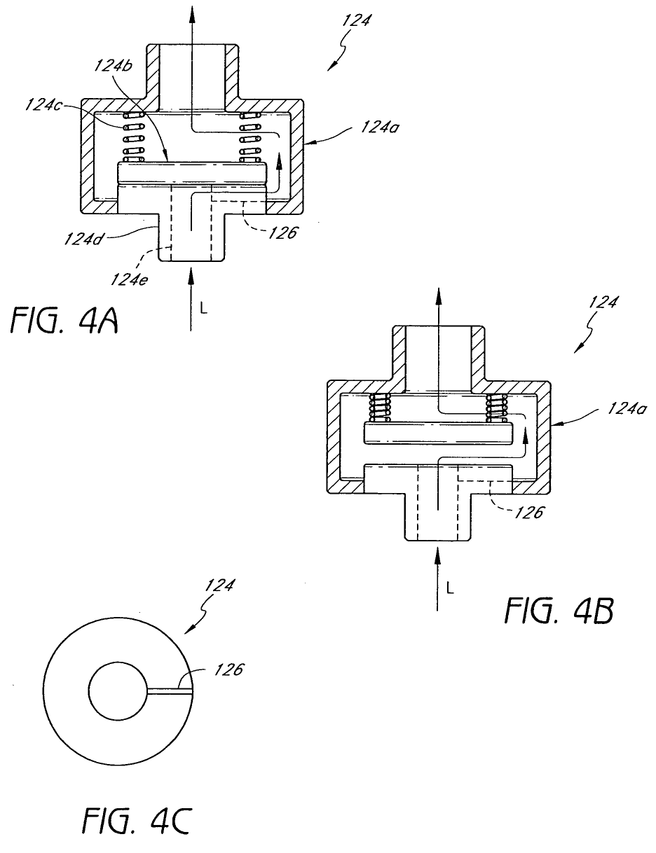

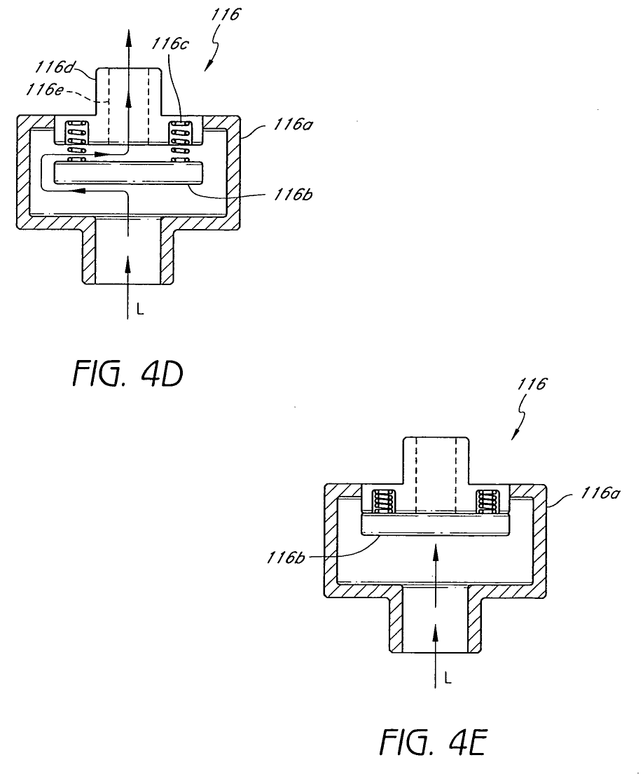

FIGS. 4A-4C schematically illustrate an exemplary but non-limiting embodiment of a valve that can be used as the valve 124. As shown in FIG. 4A, the valve 124 can include a valve body 124a and a valve member 124b biased towards a closed position with a spring 124c. The valve body 124a can include an inlet member 124d defining an inlet port 124e. Such valves are commercially available under the trade name Check Valve RVNRPH0505 from Pres Block, S.p.A.

With this configuration, as noted above, the valve 124 is normally closed, and only opens when a pressure of liquid L being pumped into the valve 124 rises above a threshold pressure. When the threshold pressure is exceeded, the pressure of the liquid L overcomes the force of the springs 124c, and thus pushes the valve member 124b away from the inlet member 124d, thus allowing the liquid to flow around the valve member 124b and out of the valve body 124a.

In some embodiments, the inlet member 124d can include a small channel 126 that allows some fluid flow at any pressure. This can provide an additional advantage in aiding the recirculation flow of water or vapor back to the reservoir 40, described in greater detail below. In an exemplary but non-limiting embodiment, the channel can be about ¼ mm wide and ¼ mm deep.

FIGS. 4D and 4E schematically illustrate an exemplary but non-limiting embodiment of a valve that can be used as the valve 116. As shown in FIG. 4D, the valve 116 can include a valve body 116a and a valve member 116b biased towards an open position with at least one spring 116c. The valve body 116a can include an outlet member 116d defining an outlet port 116e. Exemplary valves hat can be used are commercially available under the trade name Check Valve for Steam from Pres Block S.p.A., Model No. RVNRPH0505.

With this configuration, as noted above, the valve 116 is normally open, and only closes when a pressure of liquid L being pumped into the valve 116 rises above a threshold pressure. When the threshold pressure is exceeded, the pressure of the liquid L overcomes the force of the springs 116c, and thus pushes the valve member 116b toward the outlet member 116d, thus preventing the liquid from flowing around the valve member 116b and out of the valve body 1116a.

Thus, when the pump 106 is not operating and until the pump 106 generates a high enough downstream pressure to close valve 116, the valve 116 remains open and the valve 124 remains closed. Thus, any water or vapor exiting the water heater 110 will be directed to the water reservoir 40 through the recirculation line 114.

Thus, in some embodiments, the water reservoir 40 can include a return port 118 that fluidically connects the recirculation line 114 to the interior of the reservoir 40 when the water reservoir 40 is positioned on the brewing device 20. This arrangement allows water vapor to be returned into the interior of the reservoir 40. Because the water in the reservoir would normally be approximately room temperature, the water vapor discharged from the return port 118 condenses quickly in the reservoir 40. This reduces the total amount of vapor discharged from the brewer 20, thereby reducing the possibility that vapor that may escape from the brewer 20 will damage any nearby furniture, walls, or other appliances.

With continued reference to FIG. 3, when the pump 106 operates, the pressure within the system increases quickly, thereby closing the valve 116. As such, the pressure within the line 122 also rises quickly until the threshold pressure of the valve 124 is reached. When the valve 124 opens, heated water from the heater 110 is directed toward the shower head 50 and thus, hot liquid can be passed into a beverage ingredient and eventually into a cup or other container.

After the pump is deactivated, the internal pressure of the hydraulic network will begin to dissipate, primarily because valve 124 is open. Eventually, the internal pressure will reach the threshold level at which valve 124 closes. If this threshold level is higher than the level at which valve 116 opens (as was described in reference to a preferred embodiment), a closed system is created. In order to dissipate the remaining pressure within the hydraulic system, valve 116 may be configured to temporarily open immediately after the pump is deactivated. In this arrangement, steam and/or heated water will flow into the water reservoir 40 through the recirculation line 114.

As noted above, the valve 124 can include a small channel 126 that can be configured to allow liquid to pass therethrough at any pressure. In such an embodiment, the system pressure will continue to fall, even when the system pressure is above the threshold pressure of the valve 116 but below the threshold pressure of the valve 124. Thus, with sufficient time, the valve 116 eventually opens and allows water and or vapor to recirculate back to the reservoir.

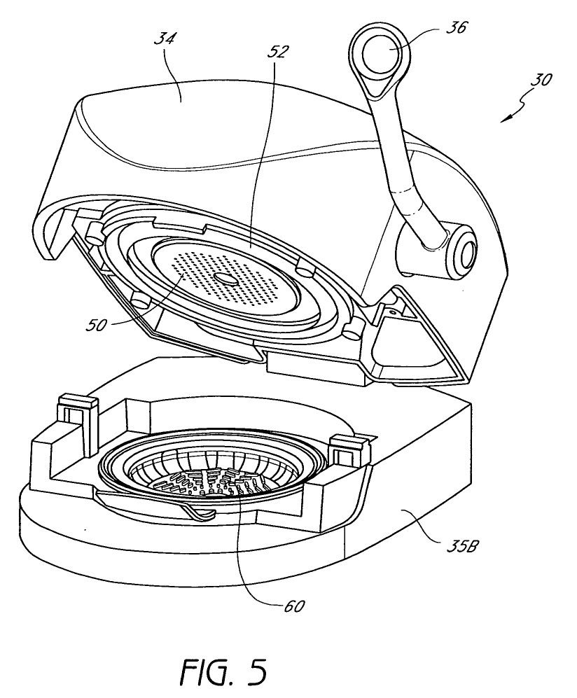

With reference to FIG. 5, the shower head 50 is attached to the bottom of the lid portion 34. The shower head 50 can comprise a plurality of openings through which the heated water, noted above, can be distributed.

The upper portion of the shower head 50 (FIG. 3) can include an inlet which connected to the brew line 122. In other arrangements, the shower head 50 can include more than one inlet.

The shower head 50 can be configured to evenly distribute the heated water through the arrangement of openings. In some embodiments, there can be approximately 170 evenly spaced openings per square inch of the shower head 50. In other variations, the openings may be smaller or larger and may be differently distributed (e.g., more or less dense, unevenly spaced, etc.).

The shower head 50 can be constructed of one or more materials capable of withstanding the temperature and pressure of the heated water. In a preferred embodiment, the shower head is manufactured of stainless steel, ceramic or another durable material suitable for contact with water. In addition, the shower head 50 is sized so as to cover substantially the entire surface area of the filter tray 60 located immediately below. Thus, the heated water can be distributed over the various portions of the filter and beverage ingredient that are placed on the filter tray 60.

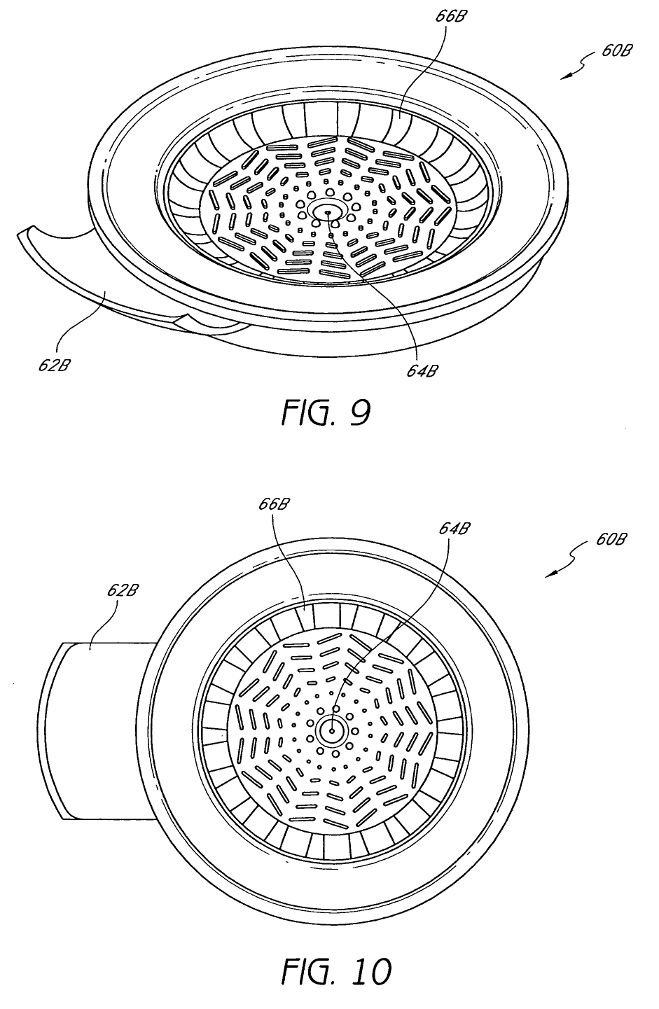

With reference to FIGS. 9 and 10, the filter tray 60 can have a circular shape, and can be dimensioned to accommodate an enclosed filter containing a beverage ingredient. Such enclosed filters are now commercially available and are generically referred to as “pods”. Thus, in the depicted arrangement, the filter tray 60 has a generally concave top surface.

The tray 60 can also include a handle 62, a number of diversion members 66 extending from the concave top surface and a center outlet 64 through configured to allow a brewed to exit the tray 60. The diversion members 66 can be sized and arranged to optimize the time period that the heated water contacts the beverage ingredient within the enclosed filter. However, that other factors may also affect the residence time of the liquid within the filter tray 60. Such factors include, but are not limited to, the size of the tray 60, the slope of the bottom surface of the tray 60, the rate at which heated water is delivered to the tray 60 from the adjacent shower head 50, the size of the outlet 64, etc.

In some embodiments, the filter tray 60 can comprise a stainless steel outer frame with a plastic insert that defines the exposed concave top surface. The plastic insert, which includes the plurality of diversion members 66 along its top surface, snap fits within the corresponding portion of the outer frame. In other variations, the filter tray 60 may be constructed of fewer or more components. As illustrated, the diversion members 66 are molded out of the plastic insert. Additional details regarding the filter tray 60 are provided below.

With reference to FIGS. 1 and 5, the filter tray 60 can be configured for removable placement directly underneath the lid portion 34 of the receiving assembly 30. A latching mechanism can be used to bring the lid portion 34, and more specifically, the shower head 50, closer or further from the filter tray 50.

Specific latching mechanisms, according to some preferred embodiments, are described in greater detail below. However, any latching mechanism can be used.

Preferably, a seal is provided between the shower head 50 and the filter tray 60 so as to generate a seal when the brewing device 20 is brewing a beverage. The seal ensures that all heated water discharged from the shower head 50 is directed into to the filter tray 60 and through the beverage ingredient in the enclosed filter.

In the embodiment illustrated in FIG. 5, the seal is a circular gasket 52 attached to the lower surface of the lid portion 34, along the outer diameter of the shower head 50. The gasket 52 is configure to mate with a corresponding surface of the filter tray 60 when the lid portion 34 is lowered. In other variations, other suitable types of gaskets can

Although not depicted in the schematic of FIG. 3, after the brewed beverage exits the filter tray 60, it flows into a spout 54 located immediately below. The spout 54 collects the brewed beverage discharged from the filter tray 60 and delivers it to a beverage container C (e.g., cup, mug, etc.) positioned on the cup tray 72.

Unlike the various components upstream of filter tray 60, the spout 54 is not pressurized. Thus, the brewed beverage collected within the spout 54 can flow under gravity into the beverage container C at an even and controlled flow rate. As illustrated in FIG. 2, the spout 54 is preferably configured to be slidably removed from the brewing device 20 to facilitate cleaning.

As shown in FIG. 2, the brewing device 20 can include a drip tray 74 configured to collect brewed beverage discharged by the spout 55 but not collected by a beverage container C. The drip tray 74 can be constructed of plastic or other materials and can be configured for removable placement within a corresponding recessed area 70 of the brewing device 20. Thus, a user can easily remove the drip tray 74 and empty its contents.

With continued reference to FIG. 2, a removable cup tray 72, positioned immediately on top of the drip tray 74, provides a substantially flat surface on which a beverage container may be placed. In some embodiments, the cup tray 72 can be constructed of stainless steel and has a plurality of openings (e.g., slots, holes, etc.) to permit the flow of liquid to the drip tray 74 below.

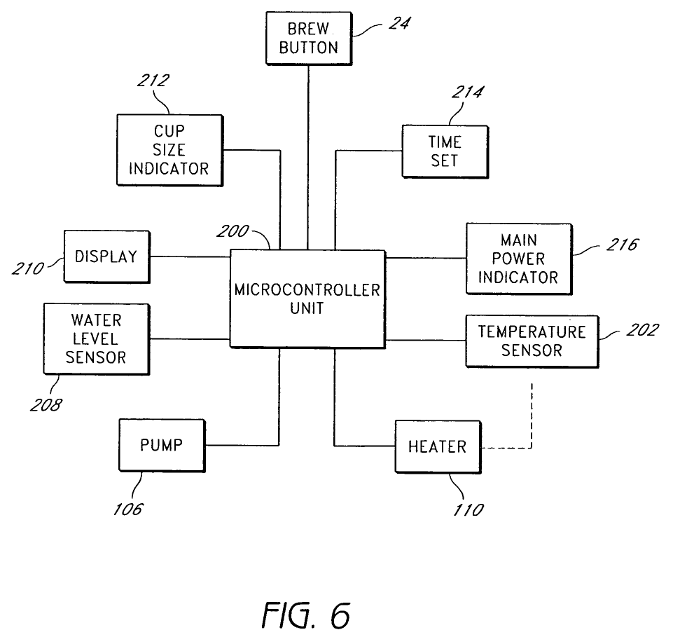

With reference to FIG. 6, a controller 200 can be used to control the operation of the various electric components included in the brewing device 20. In addition, the controller 200 can be configured to interface with the user by allowing the user to make choices that affect the operation of the brewing device 20 and by displaying certain information back to the user. The controller can be any type of controller. For example, but without limitation, the controller can be a hard-wired device with integrated circuits configured to provide the functionality described herein. Additionally, the controller can include a purpose-built or general purpose processor and memory device configured to store a control routine performed by the processor. However, other types of devices can also be used.

FIG. 6 illustrates the various components that can regulated by the controller 200, in some embodiments. As depicted in the illustrated schematic, the pump 106 and water heater 110 can be controlled by the controller 200. In some embodiments, the controller 200 is configured to activate and deactivate these devices. Alternatively, an overall control system may be more intricately arranged so as that the controller 200 is capable of controlling these devices beyond the basic on/off scheme.

For example, the controller 200 can be configured to control the speed of the pump 106 and the temperature of the heater 110. The heater 110 can be coupled to a temperature sensor 202 so as to use a feedback control method to maintain the water in the heater at a predetermined temperature.

In FIG. 6, the temperature sensor 202 is in communication with the controller 200 that, in turn, controls the heater 110. However, in other variations, the temperature sensor 202 is incorporated into a more independent thermostat device that directly controls the heater 110. Optionally, whether the controller 200 or an independent thermostat system is used to control the heater 110, a temperature adjustment input device can be used to change the predetermined temperature at which the heater 110 maintains the water.

Optionally, the water reservoir 40 can include one or more water level sensors 208. Any suitable type of level sensor can be used. Non-limiting examples include electrode sensors, pressure sensors, optical sensors (infrared, laser, etc.), ultrasonic sensors, float switches, etc. In some embodiments, the sensor 208 can comprise a floating member in the reservoir, the float having a magnetic member in it. The sensor 208 can further include a magnetic field sensor disposed in the body of the brewer 20 adjacent the reservoir 40 so that when the float drops to a predetermined position in the reservoir 40, the sensor detects the presence of the float and sends a water level signal to the controller 200.

The water level sensor 208 can be configured to provide constant feedback to the controller 200. Thus, once the level sensor 208 signals that the water in the water reservoir 40 has dropped below a threshold level, the controller 200 can prevent the brew cycle from initiating. By disabling the pump 106, heater 110 and other components of the brewing device 20, the controller 200 ensures that the brewing process will produce a beverage having the desired volume.

The brewing device 20 can include a control panel comprising one or more user input devices (e.g., buttons, knobs, etc.) and one or more output devices (LCD displays, LED, other indicators, etc.). With reference to FIG. 1, the control panel 70 can be disposed on a front surface of the brewing device 20 for easy access by a user. In the illustrated embodiment, the control panel 70 includes a main power button 24, a brew button 26, cup size selector buttons 212 and a time set button 214. However, other configurations can also be used.

The main power button 24 can be configured to control the delivery of power to the entire brewing device 20. The brew button 26 can be configured to initiate a brewing cycle.

The cup size selector buttons 212 can be configured to permit a user to choose between different volumes for the final brewed beverage. For example, in some embodiments, the brewing device 20 is configured to make either 5 oz or 8 oz of a brewed beverage. In other variations, additional volume options may be provided.

The control panel 70 can additionally include one or more time set buttons 214 that allow the user to optionally set the time and/or the date. The brewing device 20 can also be configured with a timer to permit the user to schedule a brewing cycle for a desired future time.

The control panel 70 illustrated in FIG. 1 can further comprise a main power indicator 216 and a display 210. The main power indicator 216 can include a simple sensory display such as a light emitting diode (LED) or the like. The display 210 can also be configured to provide various types of information to the user. For example, the display 210 can provide the date, the time, the cup size setting currently selected, whether or not the water level in the reservoir 40 is adequate, etc. In a preferred arrangement, the display 210 is a liquid crystal display (LCD), and is large enough so that a user can easily read the displayed information from a comfortable distance.

As shown in FIG. 6, the different input and output devices included in the control panel are preferably controlled by the controller 200. Thus, information regarding the desired volume of the brewed beverage is communicated to the controller 200, which determines, depending on information provided by the water level sensor 208, if a brew cycle can be initiated. Further, the controller 200 adjusts the operation of the pump 106 and/or heater 110, accordingly.

In operation, once the brewing device 20 has been turned on, the user can verify whether the size of the beverage to be brewed (as indicated by the display 210) is correct. The user may optionally vary the desired beverage size by manipulating the cup size selector 212 on the control panel 70.

As discussed above, the display 210 is configured to alert the user when additional water is needed in the reservoir 40. Thus, the user may also need to fill the water reservoir 40 to a minimum level.

The user can also place a container C (e.g., cup, mug, etc.) for capturing the brewed beverage on the cup tray 72 and beneath the spout 54, as illustrated in FIG. 1. An enclosed filter containing a beverage ingredient (e.g., coffee, tea, etc.) can be positioned on the filter tray 60. In some arrangements, a pod can be used. However, the inventions disclosed herein can also be used in conjunction with brewers that are configured to operate without enclosed filter-type beverage ingredients.

With continued reference to FIG. 1, after the filter tray 60 (with the filter and beverage ingredient) has been positioned underneath the lid portion 34 of the beverage ingredient receiving assembly 30, the lid portion 34 is lowered into place, bringing the shower head 50 in close proximity to the filter tray 60. The beverage ingredient receiving assembly 30 comprises one ore more latch mechanisms for securing the lid portion 34 to the corresponding lower portion. In FIG. 1, a handle 36 located on the lid portion 34 is used to manipulate the latch mechanism. Those of skill in the art will appreciate that any other suitable method of controlling the latch mechanism can also be used.

At this point, the brewing device 20 is ready to begin the brewing process, which may be initiated by pressing the brew button 24 on the control panel 70. This alerts the controller 200 to activate the pump 106.

The pump 106 draws water from the water reservoir 40 and delivers it to the heater 110. In some embodiments, the controller 200 can be configured to fill the heater 110 and heat the water therein to the predetermined temperature as soon as the brewer 20 has been turned on. As such, the brewer 20 can be ready to brew a beverage as soon as the user actuates the brew button 24.

After the water has been heated to the desired temperature, the heated water is directed towards the shower head 50 by the pump 106. Heated water enters the inlet of the shower head 50 and is preferably uniformly distributed through a plurality of openings over the adjacent filter and beverage ingredient (e.g., pod). The heated water seeps through the beverage ingredient (e.g., coffee, tea, etc.) and ends up on the filter tray 60. The brewed beverage is then channeled around a number of diversion members 66 located on the surface of the filter tray 60 before exiting through the center outlet 64. The brewed beverage passes through the spout 54 and is ultimately collected within the container C.

After the brewing cycle is completed, the latch mechanism can be disengaged to lift the lid portion 34 away from the filter tray 60. In a preferred arrangement, this is accomplished by actuating the handle 36 that is rotatably attached to the lid portion 34.

As discussed below with respect to certain embodiments, the shower head 50 can be configured to separate from the adjacent filter and beverage ingredient as the latch mechanism is disengaged. This ensures that the pod or other brewed item stays within the filter tray 60 for more convenient removal and clean-up.

The handle 62 of the filter tray 60 offers a convenient way to lift the filter tray 60 from the brewing device 20 for disposal of the pod or other brewed item. In addition, the various detachable components that come in contact with the brewed beverage (e.g., the filter tray 60, the spout 54, cup tray 72, drip tray 74, etc.) are manufactured from materials that are well-suited for washing.

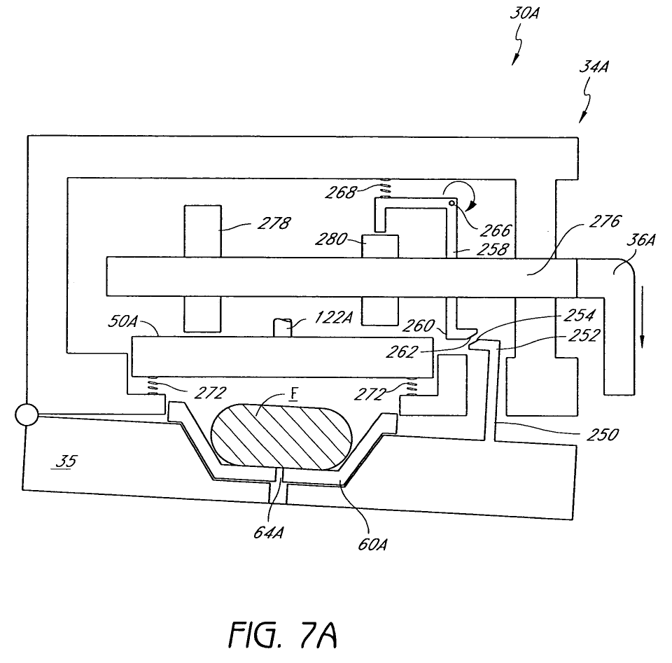

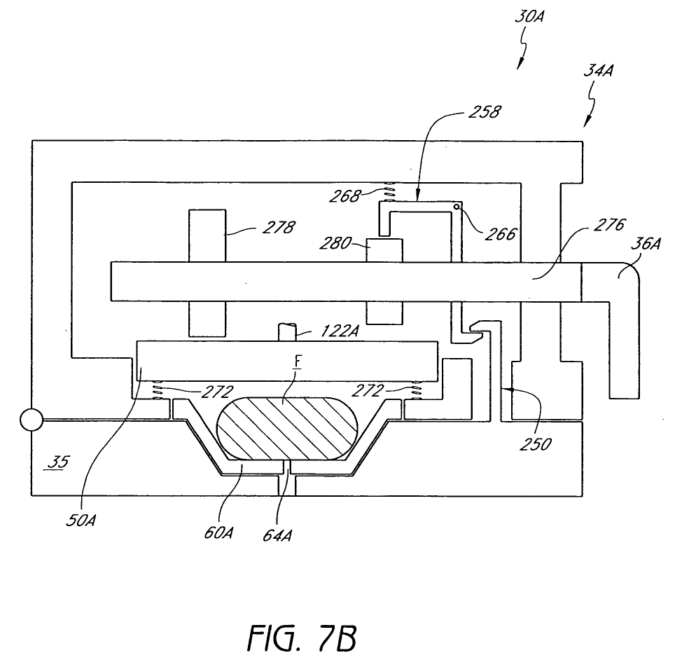

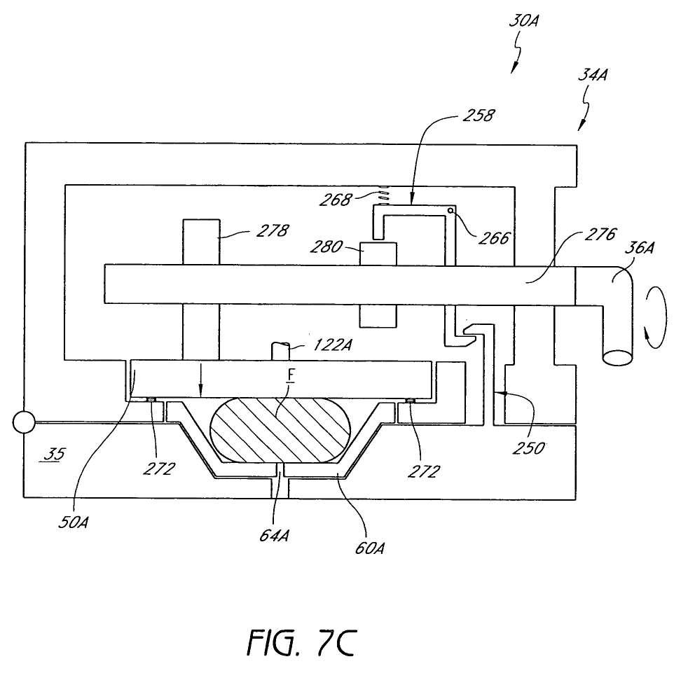

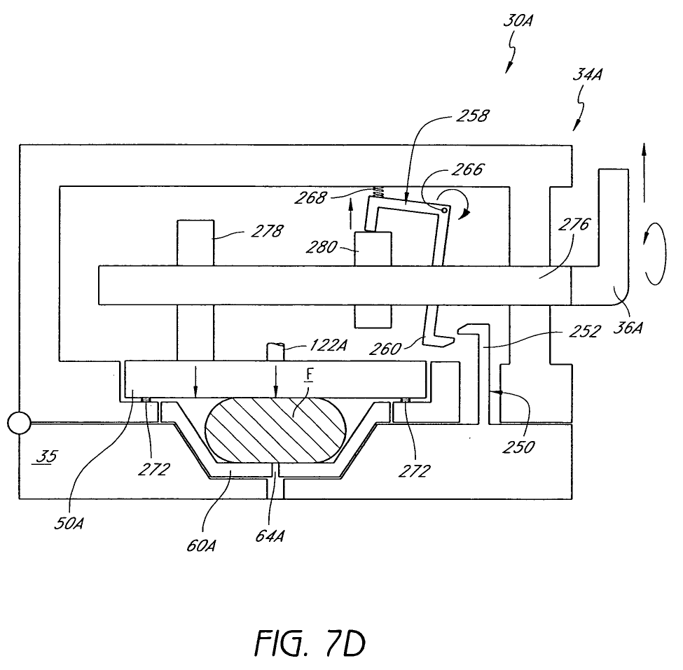

FIGS. 7A-7D schematically illustrate an embodiment of a beverage ingredient receiving assembly 30A that can be used as the beverage ingredient receiving assembly 30 illustrated in FIG. 1. A filter tray 60A, which can be removably positioned on a lower portion of the assembly 30A, is configured to accommodate an enclosed filter F containing a beverage ingredient (e.g., pod). However, as noted above, the filter tray 60A can also be configured to receive a beverage ingredient that is not enclosed in a filter.

As shown in FIG. 7A, a rigid latch member 266 extends upwardly from the lower portion 35. In some embodiments, the latch member 266 can comprise an engagement segment 252 having a sloped surface 254.

The assembly 30A further include an upper lid portion 34A that is hingedly connected to the lower portion 35. The lid portion 34A can include a latch member 258 having an oppositely-oriented engagement segment 260 with a sloped surface 262. In an arrangement where at least one of the engagement segments 252, 260 includes a sloped surface, the engagement segments 252, 260 can form a “snap latch”. In such a “snap latch” configuration, the engagement segments 252, 260 are held together by springing one of the engagement segments 252, 260 over the other.

As shown in FIG. 7A, the latch member 258 can be rotatably connected to the lid portion 34A using a hinge 266. In addition, the lid portion 34A can include a resilient member 268 that is arranged to provide a resisting force against the rotation of the latch member 258 in one direction (clockwise as illustrated).

A shower head 50A can be positioned near the bottom of the lid portion 34A and can be hydraulically connected to an inlet line 122A (partially shown) for the delivery of heated water. One or more resilient members 272 disposed in the assembly 30A can be configured to impose an upwardly oriented biasing force on the shower head 50A, away from the filter tray 60A and the lower portion of the assembly 30A. The resilient member 272 can comprise a spring or a resilient annular ring. However, any other suitable biasing member capable of producing a resilient force may be used.

With continued reference to FIG. 7A, the lid portion 34A can include an axle 276, which can be manually actuated by a handle 36A connected to the end of the axle 276. As schematically depicted, the axle 276 can comprise a cam 280 configured to engage the latch member 258 and another cam 278 configured to engage the shower head 50A.

In operation, after a filter F has been placed on the filter tray 60A, the lid portion 34A can be moved downwardly. The engagement segment 252 of latch member 250 can contact the engagement segment 260 of latch member 258 as the lid portion 34A is lowered. The sloped surfaces 254, 262 of the engagement segments 252, 260 further facilitate the movement of one latch member 250 relative to the other latch member 258 as the lid portion 34A continues to be lowered. In addition, contact between the engagement segments 252, 260 causes the latch member 258 to rotate about hinge 266. Eventually, if the lid portion 34A is sufficiently lowered, the sloped surfaces 254, 262 of the engagement segments 252, 260 slide past one another. As illustrated in FIG. 7B, the resilient member 268 forces one engagement segment 260 underneath the other engagement segment 252, effectively locking the lid portion 34A to the lower portion 35 of the assembly 30A.

In some embodiments, the shower head 50A can be moved closer to the filter F prior to the initiation of the brewing cycle so as to enhance the brewing or steeping process. Thus, in some embodiments, turning of the handle 36A rotates cams 278, 280 and the axle 276 to which the cams 278, 280 are attached.

The cam 278 can be configured such that when the axle 276 is rotated, which rotates the cam 278, the cam 278 contacts an upper surface of the shower head 50A and pushes it downwardly toward the filter F. As schematically illustrated in FIG. 7C, this results in the compression of the one or more resilient members 272. However, rotation of cam 278 in this manner does not affect the position of the latch members 250, 258, and the lid portion 34A remains effectively locked to the lower portion. In some embodiments, the lid portion 34A and the shower head 50A remain in this position during the brewing process.

The “snap latch” configuration of the engagement segments 252, 260 described above provides a further advantage in that the snap latch action can be performed when the handle 36 A is in a variety of different positions. For example, if the handle 36A is rotated towards the fully closed position such as that shown in FIG. 7C, except that the engagement segments 252, 260 are not engaged with each other, i.e., the upper portion 34A is pivoted upwardly away from the lower portion 35, the engagement segments 252, 260 can still be engaged with each other simply by pressing the upper portion 34A downwardly against the lower portion 35. As such, the engagement segments 252, 260 can still snap into engagement without damaging any parts of the assembly.

After the brewing process is completed, the handle 36A can be turned in the opposite direction, causing cam 278 to rotate back to its previous position. Consequently, the additional downward force on the shower head 50A is eliminated.

The resilient members 272 can be configured to provide sufficient force to overcome any adhesive, bonding or other forces created between the shower head 50A and the filter F during the brewing process. Thus, the wet filter F containing the now used beverage ingredient will remain within the filter tray 60A after the lid portion 34A has been lifted. With the shower head 50A and filter F now separated, the lid portion 34A may be lifted.

With reference to FIG. 7D, additional rotation of the handle 36A causes cam 280 to rotate latch member 258 against resilient member 268. The engagement segments 252, 260 move in opposite directions, and, eventually disengage from one another. Consequently, the lid portion 34A may be lifted away from the lower portion 35.

Schematic illustrations FIGS. 7A-7D and the above discussion of the beverage ingredient receiving assembly 30A has been simplified to better explain the structure and function of the various components. One of skill in the art will appreciate that the exact number, shape, size, orientation and other features of the systems and their components may be different. For example, in some embodiments, two cams 278 are used to bias the shower head 50A toward the filter tray 60A. Similarly, two sets of latching members 250, 258 and two corresponding cams 280 can be provided to lock and unlock the lid portion 34A.

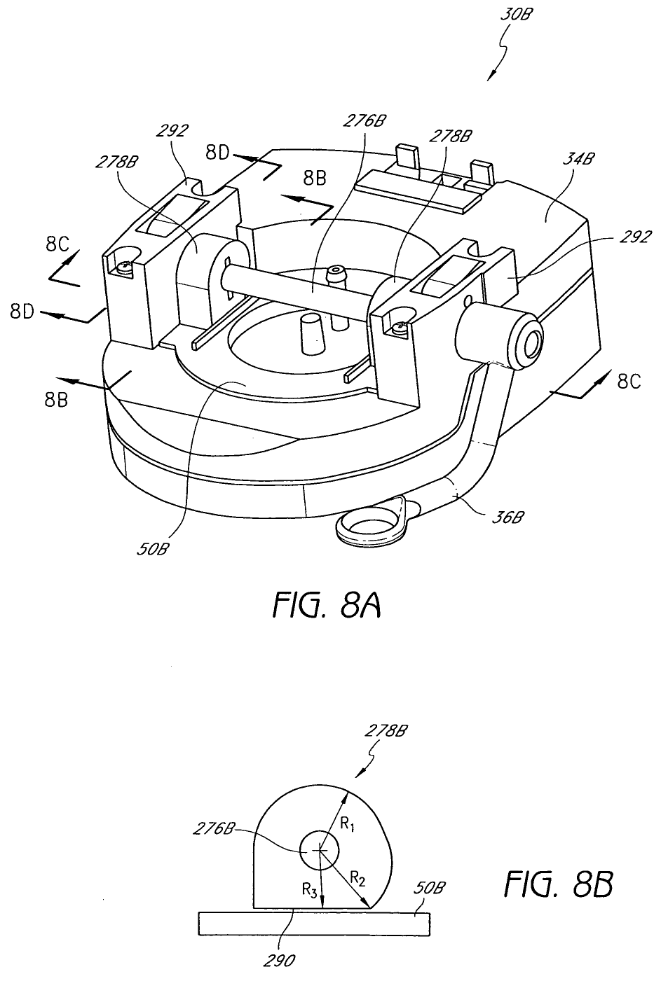

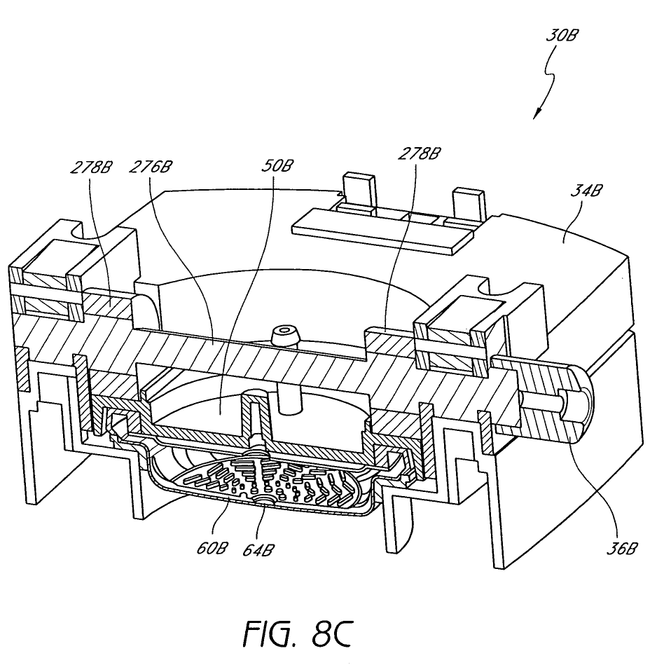

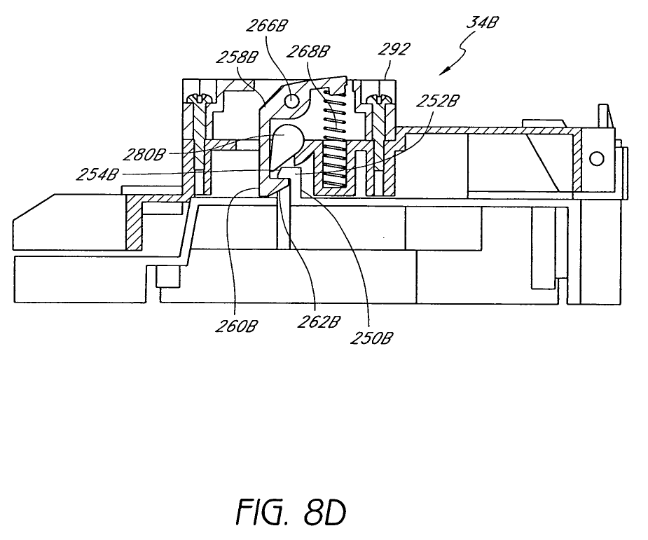

FIG. 8A illustrates another embodiment of a beverage ingredient receiving assembly 30B that can be used with the brewer 20. In this embodiment, the devices and components that are similar or the same as the corresponding components of the assemblies 30 and 30A are identified with the same reference numerals, except that “B” has added thereto.

The lid portion 34B comprises a shower head 50B, an axle 276B and a handle 36B rotatably connected to the axle 276B. The axle 276B includes two cams 278B configured to contact and vertically reposition the shower head 50B against a resilient force. Preferably, the cams 278B are identically sized and oriented, and are arranged to move in unison as the axle 276B is rotated.

As illustrated in FIG. 8B, the cams 278B preferably include an over center outer shape with a positive engagement surface 290. In the depicted embodiment, the radius of the cam 278B gradually increases with proximity to the positive engagement surface 290 (R2>R1). The cam radius (R3) near the middle of the positive engagement surface 290 is larger than the radius R2 but slightly smaller than the radius R1. Thus, as the cam 278B is rotated across the top surface of the shower head 50B, the force imposed on the shower head 50B will vary depending on the portion of the cam 278B being contacted.

In the illustrated arrangement, the greatest downward force will be imposed when the portion of the cam 278B with radius R2 contacts the shower head 50B with the radius R2 at a right angle to the upper surface of the shower head 50B. Then, as the cam 278B continues to rotate, the downward force falls until the positive engagement surface 290 of the cam 278B eventually meets the flat adjacent surface of the shower head 50B. This “over-center” action provides a tactile signal to the user that the shower head 50B has attained the desired lower position and no additional manipulation is necessary. Further, the secure interface between the flat positive engagement surface 290 and the shower head 50B further ensures that the shower head 50B will remain in this lowered position during the brewing process.

Optionally, the cam 278B can include a positive engagement surface 291 configured to provide at least some retaining force for keeping the handle 36B in the open position (the position of the handle 36A in FIG. 7D and handle 36 in FIG. 5). As such, when a user attempts to pull the handle 36B in an effort to move the lid portion 34B toward the closed position (the position shown in FIG. 8A), the positive engagement surface 291 can aid in maintaining the rotational position of the handle 36B in the open position as the lid portion 34B is moved downwardly. For example, the interaction of the positive engagement surface 291 with the upper surface of the shower head 50B and the springs 227B which push the shower head 50B toward the positive engagement surface 291 can provide some retaining force against the rotation of the handle 36B. Then, after the lid portion 34B is brought down into contact with a portion of the lower portion 35B, the user can further rotate the handle 36B until the positive engagement surface 290 contacts the shower head 50B.

FIG. 8C further illustrates the interaction between the handle 36B, the shaft 276B, the two cams 278B, the shower head 50B and the filter tray 60B. In some embodiments, one or more springs or other suitable biasing members (not shown) can be positioned underneath the shower head 50B to impose an upwardly-oriented resilient force on the shower head 50B. As discussed above, this ensures that the filter or other brewed item (e.g., pod) situated on the filter tray 60B does not adhere to bottom of the shower head 50B when lid portion 34B is lifted.

In the depicted arrangement, the two cams 278B are located on opposite ends of the shower head 50B to create a more evenly distributed downward force. It will be appreciated that the exact number, shape, size, orientation and other features of the cams 278B and other components of the beverage ingredient receiving assembly 30B can be varied.

With continued reference to FIG. 8A, the lid portion 34B can include two latch mechanism assemblies, each located within a housing 292 at opposite ends of the lid portion 34B. Fewer or more latch mechanism assemblies may alternatively be used.

In FIG. 8D, the cross-sectional view through the housing 292 illustrates the interaction between the latch members 250B, 258B, the cam 280B, the hinge 266B and the spring 268B when the lid portion 34B is secured to the lower portion. Manipulation of the handle 36B causes the cam 280B to rotate (clockwise as illustrated). The cam 280B contacts the upper latch member 258B and causes it to rotate about hinge 266B against the resilient force created by the spring 268B. As the cam 280B continues to rotate, the engagement segment 260B of latch member 258B moves past the engagement segment 252B of latch member 250B, permitting the lid portion 34B to be lifted.

FIGS. 9 and 10 illustrate an embodiment of the filter tray 60B. The filter tray 60B can comprise a handle 62B to facilitate placement in and removal from the brewing device 20. The filter tray 60B can have a generally concave recessed portion capable of accommodating a filter or other brewing item (e.g., pod). However, the tray 60B can also be configured to receive beverage ingredients that are not enclosed in a filter. In an exemplary but non-limiting embodiment, the diameter of the concave open portion of the filter tray 60B is approximately 2½ inches and the open surface of the filter tray 60B can have a gradual slope towards the center outlet 64B, which is approximately between 1/16 and ⅛ inches in diameter. However, other suitable shapes and dimensions for the filter tray 60B may be used.

As depicted, the open portion of the filter tray 60B can comprise a plurality of diversion members 66B. In the illustrated exemplary but non-limiting embodiment, approximately 100 diversion members 66B of varying size, shape and orientation are distributed along the tray surface.

In some embodiments, the height of the diversion members 66B is approximately 1/16 of an inch. The majority of the diversion members 66B have either a circular or an elongated shape with rounded edges.

In FIGS. 9 and 10, the size of the diversion members 66B gradually decreases with proximity to the center outlet 64B. Except for the circular diversion members 66B positioned immediately around the center outlet 64B, the diversion members 66B are generally arranged in radial rows of five. Preferably, the orientation of the elongated diversion members 66B is more tangential than radial. Additionally, the elongated diversion members 66B can be skewed relative to a purely tangential direction. Optionally, the direction in which the diversion members 66B are skewed relative to tangential alternates from one radial row to the next. The diversion members 66B can be plastic and molded into the surface of the filter tray 60B. However, other materials can also be used.

The arrangement of the diversion members 66B improves the brewing process by optimizing the contact time between the heated water and the beverage ingredient within the filter tray 60B. Heated water is distributed by the shower head 50 over the adjacent beverage ingredient (e.g., coffee, tea, etc.). The heated water steeps through the beverage ingredient and ends up on the surface of the filter tray 60B. Preferably, the steeped liquid is routed through multiple paths created by the different diversion members 66B, thereby prolonging its exposure to the beverage ingredient, but allowing the liquid from being blocked or stopped by the diversion members 66B. Consequently, the brewed beverage is substantially prevented from directly flowing towards the center outlet 64B of the filter tray 60B.

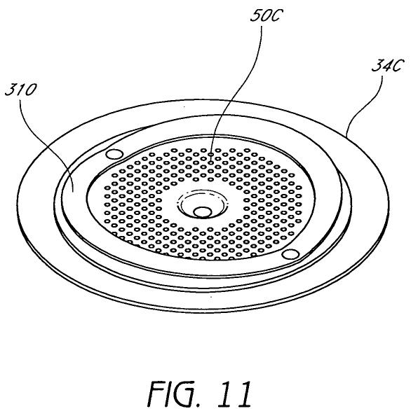

FIG. 11 illustrates another embodiment of a lid portion 34C comprising an annular ring 310 immediately below the shower head 50C. The annular ring 310 can be constructed of stainless steel or other suitable materials.

The annular ring 310 can be attached to the outside portion of the adjacent shower head 50C. The annular ring 310 can be tack welded to the shower head 50C at 2 places located opposite of one another (180 degrees). Those of skill in the art will appreciate that the annular ring 310 may be joined to the shower head 50C is additional places and/or using other attachment methods (e.g., bolt, rivet, glue, etc.). As shown in FIG. 11, the annular ring 310 has a slight concavity or other bend so as to provide it with a certain resiliency in the non-planar direction.

After completion of a brew cycle, the annular ring 310 can act to push away the filter or other brewed item (e.g., pod) positioned within the adjacent filter tray (not shown). Preferably, the ring 310 is sufficiently resilient to overcome any adhesive or other bonding forces created by the brewing process between the shower head 50C and the filter or other brewed item. Thus, the ring 310 exerts a downward force on the filter or other brewed item before the lid portion 34C is even opened. Depending on the ring material and the method used to attached the ring 310 to the shower head 50C, the concavity or bend of the ring 310 can be easily modified to adjust the downward force exerted on the filter or other brewed item.

Although this invention has been disclosed in the context of a certain preferred embodiment and examples, it will be understood by those skilled in the art that the present invention extends beyond the specifically disclosed embodiment to other alternative embodiments and/or uses of the invention and obvious modifications and equivalents thereof. In addition, while several variations of the invention have been shown and described in detail, other modifications, which are within the scope of this invention, will be readily apparent to those of skill in the art based upon this disclosure. It is also contemplated that various combination or sub-combinations of the specific features and aspects of the embodiments or variations may be made and still fall within the scope of the invention. It should be understood that various features and aspects of the disclosed embodiment can be combined with or substituted for one another in order to form varying modes of the disclosed invention. Thus, it is intended that the scope of the present invention herein-disclosed should not be limited by the particular disclosed embodiments described above, but should be determined only by a fair reading of the claims that follow.

What is claimed is:

1. A brewing device comprising:
a diffuser member configured to disperse a fluid over a beverage ingredient, the diffuser member being mounted within a housing member and configured to move relative to the housing member along a movement path, the diffuser member being disposed such that a surface of the diffuser member is exposed to the outside of the housing member, the movement path extending toward and away from the housing member;
at least one biasing member configured to bias the diffuser member toward the housing member along the movement path; and
at least one positioning member configured to move the diffuser member away from the housing along the movement path against the bias of the biasing member.

2. The brewing device of claim 1, wherein the biasing member is configured to impose a substantially upwards biasing force on the diffuser member.

3. The brewing device of claim 2, wherein the biasing member comprises a spring.

4. The brewing device of claim 1, wherein the positioning member is configured to move the diffuser by moving an actuation member.

5. The brewing device of claim 4, wherein the positioning member and the actuation member are attached to a rotatable rod.

6. The brewing device of claim 2, wherein the upwards force created by biasing member is configured to move diffuser member away from a lower surface.

7. The brewing device of claim 1, wherein positioning member is a cam.

8. The brewing device of claim 7, wherein cam is configured and arranged to provide an over-center configuration.

9. A brewing device comprising:
an upper portion including a diffuser member and at least one upper latching member; and
a lower portion hingedly connected to the upper portion and configured to hold a brewable ingredient, the lower portion including at least one lower latching member configured to lockingly engage the upper latching member as the upper portion is moved towards lower portion.

10. The brewing device of claim 7, wherein at least one of upper latching member and lower latching member includes a sloped surface configured to form a snap-latch arrangement allowing the upper latching member and lower latching member to snap into a locked engagement when they are moved together.

11. The brewing device of claim 7 further comprising at least one disengagement member configured to move at least one of the upper latching member and lower latching member so as to cause upper latching member and lower latching member to move out of a locking position.

12. The brewing device of claim 11, wherein the disengagement member is configured to move latching member by moving an actuation member.

13. The brewing device of claim 12, wherein the disengagement member and the actuation member are attached to a rotatable rod.

14. The brewing device of claim 13, further comprising at least one positioning member configured to move the diffuser member relative to the upper portion, wherein rotation of the rotatable rod can selectively control the position of the diffuser member.

15. The brewing device of claim 11, wherein disengagement member is a cam.

16. A brewing device comprising:
a tray configured to hold a filter and a beverage ingredient and comprising at least one outlet positioned on the bottom surface of the tray; and
a plurality of diversion members distributed along the bottom surface of the tray,
wherein the diversion members are configured in more of a tangential than a radial arrangement and skewed relative to both a purely tangential and a purely radial arrangement.

17. The brewing device of claim 16, wherein the diversion members are formed onto the bottom surface of the tray.

18. The brewing device of claim 16, wherein the length of the diversion members positioned toward the center of the tray is generally shorter than the length of diversion members positioned further from the center of the tray.

19. The brewing device of claim 16, wherein the length of diversion members gradually decreases with proximity to the center of the tray.

20. The brewing device of claim 16, wherein the length of diversion members ranges between 1/32 inch and ¼ inch.

21. A brewing device comprising:
a tray configured to hold a filter and a brewable ingredient;
a diffuser member positioned upstream of the tray and configured to discharge a fluid toward the filter and brewable ingredient; and
at least one biasing member configured to impose a resilient force tending to move the diffuser member away from the tray.

22. The brewing device of claim 21, wherein the biasing member is a resilient member attached to a portion of the diffuser member.

23. The brewing device of claim 22, wherein the resilient member is an annular ring with at least one non-planar portion.

24. The brewing device of claim 22, wherein the resilient member is intermittently attached to the diffuser member.

25. The brewing device of claim 23, wherein the resilient member is welded to the diffuser member in at least two locations.
